(19) United States
(12) Patent Application Publication
(10) Pub. No.: US 2024/0360008 A1
(43) Pub. Date: Oct. 31, 2024

(54) SYSTEM FOR REMOVING PER- AND POLYFLUOROALKYL SUBSTANCES (PFAS) FROM A SOLUTION HAVING PFAS THEREIN USING FOAM FRACTIONATION

(71) Applicant: Emerging Compounds Treatment Technologies, Inc., North Little Rock, AR (US)

(72) Inventors: Christopher Hutchins, Winthrop, ME (US); Steven E. Woodard, Cumberland, ME (US); Paul Rodriguez, Scarborough, ME (US)

(21) Appl. No.: 18/647,730

(22) Filed: Apr. 26, 2024

Related U.S. Application Data
(60) Provisional application No. 63/462,398, filed on Apr. 27, 2023.

(51) Int. Cl. C02F 1/24; C02F 101/36

(52) U.S. Cl. CPC C02F 1/24; C02F 2101/36

(57) ABSTRACT

A system for removing PFAS from a solution having PFAS therein using foam fractionation is featured. The system includes at least one first foam fractionation subsystem including a vessel configured to receive the solution having PFAS therein and configured to generate microbubbles, turbulence, and foam to remove a majority of the PFAS and generate a treated solution and a flow of foam having the removed PFAS therein. The system also includes a heating and dehumidification subsystem coupled to the at least one foam fractionation subsystem and configured to generate a flow of heated dehumidified gas. The at least one foam fractionation subsystem is configured to output the flow of foam having the removed PFAS therein into the flow of heated dehumidified gas such that the flow of a heated dehumidified gas collapses the flow of foam having the removed PFAS therein into a flow of liquid having the removed PFAS therein.

### RELATED APPLICATIONS

This application claims benefit of and priority to U.S. Provisional Application Ser. No. 63/462,398 filed Apr. 27, 2023, under 35 U.S.C. §§ 119, 120, 363, 365, and 37 C.F.R. § 1.55 and § 1.78, which is incorporated by reference herein.

### FIELD OF THE INVENTION

This invention relates to a system for removing per-and polyfluoroalkyl substances (PFAS) from a solution having PFAS therein using foam fractionation.

### BACKGROUND OF THE INVENTION

Foam fractionation has been utilized in the large-scale aquarium industry for decades. It works by introducing turbulence combined with thousands of microbubbles at the bottom of a large water column while the dirty water enters at the top of the column and exits at the bottom. As the water is moving down the column toward the exit, the bubbles work to trap particles and unwanted waste, floating contaminants to the surface. In the aquarium industry this is typically targeting fish waste and proteins, floating the particulate to the surface where it may be removed via a skimmer. Foam fractionation may have a dramatically lower cost of operation when compared to more intense membrane, and filtration technologies and has gained major popularity in the aquarium, and aquaculture industries due to the ease of operation and effectiveness of removal.

PFAS compounds are polar, with charged hydrophilic heads and fluorinated hydrophobic tails. This chemical structure results in molecules that seek the air-water interface. This is a major reason why PFAS is the backbone of Aqueous Film Forming Foam (AFFF) or firefighting foam. Much in the way foam fractionation works to remove proteins in an aquarium environment, foam fractionation also has its place in groundwater remediation, water, and wastewater treatment, specifically for the removal of PFAS. The introduction of turbulence and thousands of microbubbles at the base of a water column creates immense surface area for PFAS compounds to join the air-water interface, and float with the bubbles to the top of the column where they can be separated from the treated water (raffinate) and concentrated into foam or foamate.

Conventional foam fractionation systems and methods typically produce a large volume of waste foam or foamate having removed PFAS therein, which may be difficult and cumbersome to handle and/or further treat.

Thus, there is a need for a foam fractionation system and method which reduces the volume of waste foam or foamate having removed PFAS therein and which creates a concentrated flow of a liquid having removed PFAS therein and which reduces the volume of PFAS waste.

### BRIEF SUMMARY OF THE INVENTION

In one aspect, a system for removing per-and polyfluoroalkyl substances (PFAS) from a solution having PFAS therein using foam fractionation is featured. The system includes at least one first foam fractionation subsystem including a vessel configured to receive the solution having PFAS therein and configured to generate microbubbles, turbulence, and foam to remove a majority of the PFAS and generate a treated solution and a flow of foam having the removed PFAS therein. The system also includes a heating and dehumidification subsystem coupled to the at least one foam fractionation subsystem and configured to generate a flow of heated dehumidified gas. The at least one foam fractionation subsystem is configured to output the flow of foam having the removed PFAS therein into the flow of heated dehumidified gas such that the flow of a heated dehumidified gas collapses the flow of foam having the removed PFAS therein into a flow of liquid having the removed PFAS therein.

In one example, the flow of heated dehumidified gas may be configured to reduce a volume of the flow of foam having the removed PFAS therein. The flow of liquid having the removed PFAS therein and the heated dehumidified gas may be directed to a foamate break tank. A pitched line coupled between the vessel and the foamate break tank may be configured to direct the flow of liquid having the removed PFAS therein to the foamate break tank. The flow of heated dehumidified gas may be recirculated from the foamate break tank to the heating and dehumidification subsystem and to the vessel. Recirculating the heated and dehumidified gas may be configured to reduce an energy input required to collapse and/or reduce the volume of the foam. The at least one foam fractionation subsystem may include a diffuser subsystem configured to generate the microbubbles and/or nanobubbles, the turbulence, and the foam. The at least one foam fractionation subsystem may include a venturi eductor configured to introduce and mix a gas into a recycled solution having PFAS therein and generate a two-phase flow of microbubbles and a solution having PFAS therein and a modified diffuser including a vortex tee inside a cylindrical baffle configured to receive the two-phase flow and induce rotational movement that generates intense mixing and turbulence to maximize the formation and distribution of microbubbles and foam to enhance removal of PFAS from the solution having PFAS therein. The vortex tee may be spaced from a surface of the cylindrical baffle by a predetermined distance to maximize the rotational movement and turbulence of the two-phase flow of microbubbles and water having PFAS therein. The cylindrical baffle may be sized and positioned to separate the two-phase flow of microbubbles and water having PFAS therein from the treated solution having a majority of the PFAS removed. The at least one pump may be coupled to the vessel and the venturi eductor. The at least one pump operated in cavitation such that the venturi eductor generates a two-phase flow of microbubbles and/or nanobubbles and the solution having PFAS therein. The modified diffuser may be configured to receive the two-phase flow and induce rotational movement that generates intense mixing and turbulence to augment the formation and distribution of microbubbles and/or nanobubbles and foam to enhance removal of PFAS from the solution having PFAS therein. The system may include a super-loading subsystem which may be configured to receive the flow of liquid having the removed PFAS therein and configured to remove PFAS from the flow by sorbing PFAS onto adsorptive media to create a concentrated PFAS waste product.

In another aspect, a method for removing per-and polyfluoroalkyl substances (PFAS) from a solution having PFAS therein using foam fractionation is featured. The method includes receiving the solution having PFAS therein and generating microbubbles, turbulence, and foam to remove a majority of the PFAS, generating a treated solution and a flow of foam having the removed PFAS therein, generating a flow of heated dehumidified gas, and outputting the flow of foam having the removed PFAS therein into the flow of heated dehumidified gas such that the flow of a heated dehumidified gas collapses the flow of foam having the removed PFAS therein into a flow of liquid having the removed PFAS therein.

In one example, the flow of heated dehumidified gas may be configured to reduce a volume of the flow of foam having the removed PFAS therein. The flow of liquid having the removed PFAS therein and the heated dehumidified gas may be directed to a foamate break tank. The flow of heated dehumidified gas may be recirculated from the foamate break tank to the heating and dehumidification subsystem and to the vessel. Recirculating the heated and dehumidified gas may be configured to reduce an energy input required to collapse and/or reduce the volume of the foam. The method may include a super-loading process may be configured to receive the flow of liquid having the removed PFAS therein and configured to remove PFAS from the flow by sorbing PFAS onto adsorptive media to create a concentrated PFAS waste product.

In another aspect, a system for removing long-chain and short-chain PFAS from a solution having PFAS therein using foam fractionation is featured. The system includes at least one first foam fractionation subsystem configured to receive the solution having PFAS therein and configured to generate microbubbles, turbulence, and foam to remove a majority of long-chain PFAS and generate a treated flow of a solution having a majority of the long-chain PFAS removed. The system also preferably includes at least one foam boosting subsystem configured to introduce at least one foam boosting agent into the treated flow of solution having a majority of the long-chain PFAS removed. The at least one second foam fractionation subsystem is configured to receive the treated solution having a majority of the long-chain PFAS removed and the foam boosting agent. The at least one second foam fractionation subsystem is configured to generate microbubbles, turbulence, and foam. The foam boosting agent is preferably configured to augment the formation of foam to facilitate the removal of short-chain PFAS. The at least one second foam fractionation subsystem is configured to generate a treated flow of a solution having a majority of the long-chain PFAS removed and a majority of the short-chain PFAS removed.

In one example, the foam boosting agent may include at least one supplemental surfactant. The at least one supplemental surfactant may include an anionic, cationic, zwitterionic, nonionic, and/or a protein-based surfactant.

In another aspect, a method for removing long-chain and short-chain PFAS from a solution having PFAS therein using foam fractionation is featured. The method includes receiving the solution having PFAS therein and generating microbubbles, turbulence, and foam to remove a majority of long-chain PFAS, generating a treated flow of a solution having a majority of the long-chain PFAS removed, introducing at least one foam boosting agent into the treated flow of solution having a majority of the long-chain PFAS removed, receiving the treated solution having a majority of the long-chain PFAS removed and the foam boosting agent, generating microbubbles, turbulence, and foam, the foam boosting agent is preferably configured to augment the formation of foam to facilitate the removal of short-chain PFAS, and generating a treated flow of a solution having a majority of the long-chain PFAS removed and a majority of the removed short-chain PFAS removed.

In one example, the foam boosting agent may include at least one supplemental surfactant. The at least one supplemental surfactant may include an anionic, cationic, zwitterionic, nonionic, and/or a protein-based surfactant.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic block diagram showing one example of the primary components of the system for removing PFAS from a solution having PFAS therein using foam fractionation;

FIG. 2 is three-dimensional side view showing in further detail one example of pitched line coupled between heating and dehumidification subsystem 26 and foamate break tank shown in FIG. 1;

FIG. 3 is a schematic block diagram showing another example of the primary components of the system for removing PFAS from a solution having PFAS therein using foam fractionation;

FIG. 4 is a schematic top view showing in further detail the structure of the modified diffuser subsystem including vortex tee and cylindrical baffle shown in FIG. 3;

FIG. 5 is a flow chart showing one example of the primary steps of method removing PFAS from a solution having PFAS therein using foam fractionation;

FIGS. 6A and 6B are schematic block diagrams showing one example of the primary components of system for removing long-chain and short-chain PFAS from a solution having PFAS therein using foam fractionation; and

FIG. 7 is a flow chart showing one example of the method for removing long-chain and short-chain PFAS from a solution having PFAS therein using foam fractionation.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

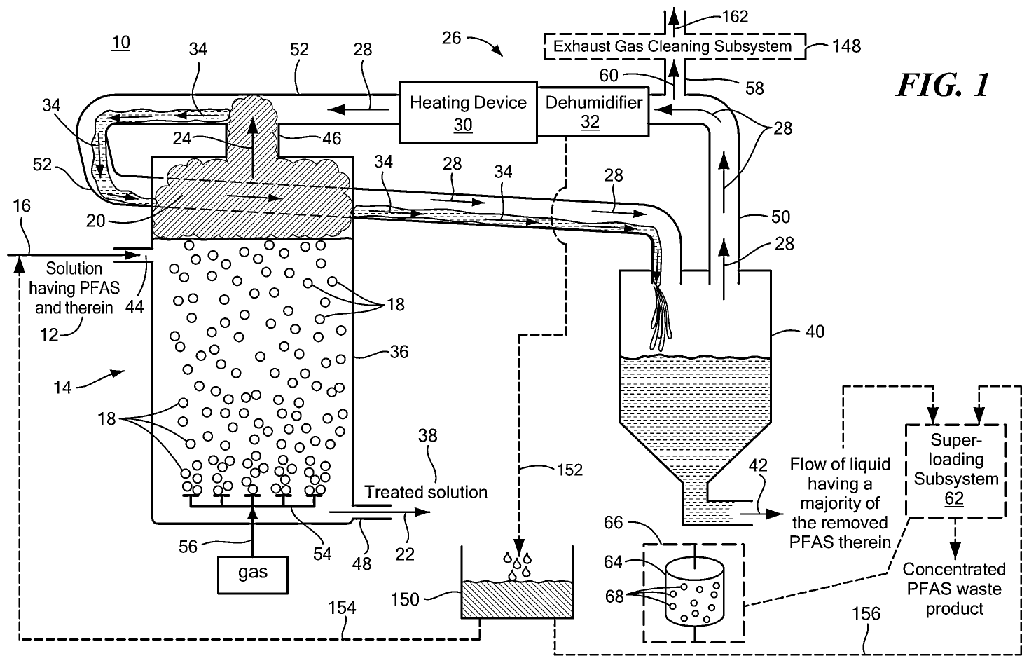

There is shown in FIG. 1, one example of system 10 for removing PFAS from solution 12 having PFAS therein using foam fractionation. Solution 12 may include one or more of industrial wastewater, municipal wastewater, contaminated groundwater, landfill leachate, dilute AFFF from fire protection systems, or similar solution contaminated with PFAS.

System 10 includes at least one foam fractionation subsystem 14 which receives solution 12 having PFAS therein. In one design, fractionation subsystem 14 may receive a flow of solution 12 having PFAS therein, e.g., flow 16 of solution 12 having PFAS therein. As disclosed herein, “flow” may be a continuous flow often utilized in a flow-through reactor or vessel, or an intermittent flow typically utilized in sequencing batch processing.

Foam fractionation subsystem 14 generates microbubbles, exemplarily indicated at 18, turbulence, and foam, also referred to herein as foamate, exemplarily indicated at 20, to remove a majority of the PFAS from solution 12 and generate treated solution 38. As defined herein, a majority is preferably greater than about 50% of the PFAS in solution 12. In one design, foam fractionation subsystem 14 may generate flow 22, also referred to herein as raffinate 22, of treated solution 38. As defined herein, flow 22 of treated solution 38 preferably contains less than about 50% of the PFAS in solution 12. Foam fractionation subsystem 14 also generates flow 24 of foam or foamate having the removed PFAS therein.

System 10 also includes a heating and dehumidification subsystem 26 coupled to vessel 36 as shown which generates flow 28 of heated dehumidified gas. In one design, heating and dehumidification subsystem 26 preferably includes heating device 30 and dehumidifier 32. In other examples, heating device 30 and dehumidifier 32 may be configured as a single device.

Foam fractionation subsystem 14 preferably outputs flow 24 of foam having the removed PFAS therein into the flow 28 of heated dehumidified gas as shown such that flow 28 of a heated dehumidified gas collapses flow 24 of foam having the removed PFAS therein into flow 34 of liquid having the removed PFAS therein. The heated dehumidified gas in flow 28 removes water from foam 20 in flow 24 which reduces the volume of foam or foamate 20 generated by system 10 and the method thereof (discussed below). The heat in flow 28 efficiently and effectively collapses foam 20 into flow 34 of liquid having removed PFAS therein. The combination of removing water from the foam having removed PFAS therein and efficiently collapsing the foam into a liquid as discussed above minimizes the amount to PFAS waste generated by system 10 and the method thereof.

In one design, flow 34 of liquid having the removed PFAS therein, and flow 28 of heated dehumidified gas are preferably directed to foamate break tank 40, which preferably collects flow 34 of liquid having the removed PFAS therein. Foamate break tank 40 preferably outputs flow 42 of liquid having the removed PFAS therein. Flow 42 may be a waste product that may be disposed, destroyed, or further treated, as discussed below.

In one example, foam fractionation subsystem 14 preferably includes vessel 36 having inlet 44 which preferably receives flow 16, outlet 46 which preferably outputs flow 24, and outlet 48 which preferably outputs flow 22.

In one example, flow 28 of the heated dehumidified gas may be recirculated from foamate break tank 40 to heating and dehumidification subsystem 26 by line 50 and to vessel 16 by line 52. Recirculating flow 28 of heated, and dehumidified gas preferably reduces the energy input required to collapse flow 24 of foam into flow 34 of liquid having the removed PFAS therein.

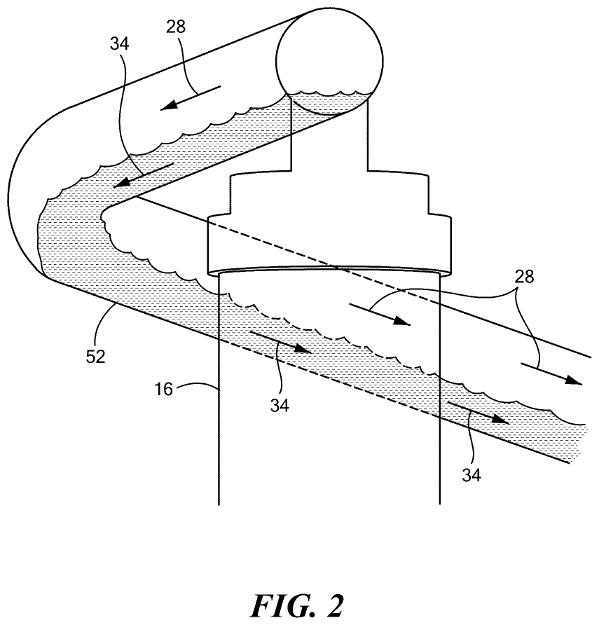

In one example, line 52 coupled between heating and dehumidification subsystem 26 and foamate break tank 40 may be pitched to direct flow 34 of liquid, having the removed PFAS therein to foamate break tank 40, e.g., as shown in FIG. 2.

Foam fractionation subsystem 14 preferably includes diffuser subsystem 54, which preferably generates microbubbles 18, turbulence, and foam 20. In one example, diffuser subsystem 54 preferably introduces flow 56 of a gas, e.g., air, nitrogen, carbon dioxide, or similar type gas, to generate and distribute microbubbles 18, turbulence, and foam 20.

Foam fractionation subsystem 14 may include exhaust vent 58 which preferably outputs flow 60 of exhaust gas. Flow 60 of exhaust gas is preferably approximately equal to flow 56 of gas. Flow 60 may include trace amounts of PFAS. To remove any PFAS in flow 60, foam fractionation subsystem 14 may include exhaust gas removal subsystem 148 which preferably removes a majority of the PFAS from flow 60. In one example, exhaust gas cleaning subsystem 148 may include a carbon canister, or similar type device.

Foam fractionation subsystem 14 may also include collection tank 150, which preferably receives condensate from dehumidifier 32 by line 152. The condensate in collection tank 150 may include PFAS and may be directed back to inlet 44 by line 154 and/or to super-loading subsystem 62 (discussed below) as flow 156.

In one design, foam fractionation subsystem 14 may include super-loading subsystem 62 which preferably receives flow 42 of liquid having a majority of the removed PFAS therein and/or flow 156 condensate in collection tank 150 as shown. In one example, super-loading subsystem 62 preferably removes PFAS from flow 42 and/or flow 156 by adsorbing PFAS onto an adsorptive media.

In one example, super-loading subsystem 62 may be configured as a small vessel, e.g., vessel 64 shown in caption 66 having an adsorptive media 68 therein. Adsorptive media 68 preferably absorbs the PFAS in flow 42 to create a concentrated PFAS waste product that may be disposed of or destroyed. Adsorptive media 68 may include ion exchange resin, granular activated carbon (GAC), synthetic media, or a combination thereof, or similar type adsorptive media. See e.g., U.S. Pat. Nos. 10,287,185, 10,913,668 and 11,027,988 by the assignee hereof, incorporated by reference herein.

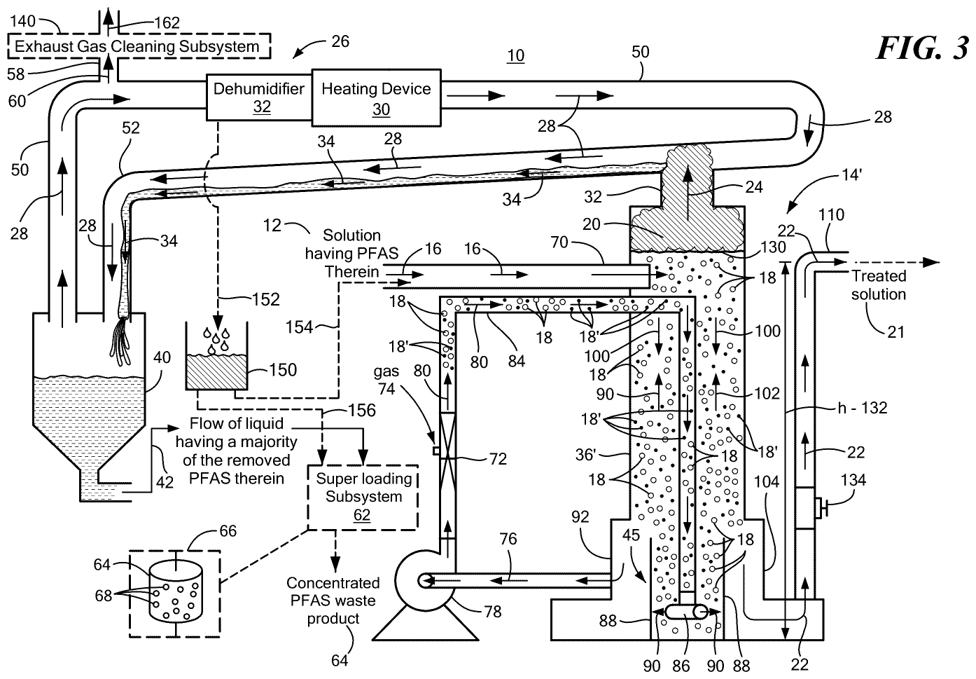

In another design, foam fractionation subsystem 14′, FIG. 3, where like parts have been given like numbers, preferably includes vessel 36′ which preferably includes inlet 70, which receives solution 12 having PFAS therein. In one design, similar as discussed above, foam fractionation subsystem 14′ may receive flow 16 of solution 12 having PFAS therein, which may be continuous flow or an intermittent flow.

In this example, foam fractionation subsystem 14′ preferably includes venturi eductor 72, which introduces and mixes gas 74, e.g., air, nitrogen, carbon dioxide, or similar type gas, into recycled flow 76 of solution 12 having PFAS therein, preferably provided by pump 78. Venturi eductor 72 preferably generates two-phase turbulent flow 80 of microbubbles 18 and solution 12 having PFAS therein in line 84. In one example, venturi eductor 72 may be available from Mazzei Injector Company, LLC., Bakersfield, CA 93307.

In one design, venturi eductor 72 may generate nanobubbles, exemplarily indicated at 18′, by operating pump 78 in cavitation. Nanobubbles 18′ preferably increase the surface area of air-water interface thereby enhancing efficiently of foam fractionation. In other examples, system 10 and the method thereof may include a nanobubble generation subsystem (not shown) to generate nanobubbles 18′, as known by those skilled in the art.

Foam fractionation subsystem 14′ also preferably includes modified diffuser subsystem 45 which augments the production and distribution of microbubbles 18 and/or nanobubbles 18′, and foam or foamate 20. Modified diffuser subsystem 45 preferably includes vortex tee 86 disposed inside cylindrical baffle 88 as shown. Vortex tee 86 receives the two-phase flow 80 by line 84 and induces rotational movement or vortex formation of the two-phase flow inside cylindrical baffle 88 to generate intense mixing and turbulence. The intense mixing and turbulence provided by modified diffuser subsystem 45 significantly increases the production and distribution of microbubbles 18 and/or nanobubbles 18′, e.g., when compared to diffuser 44, FIG. 1, such that the more PFAS in flow 16 attach to the increased concentration of microbubbles 18 and/or nanobubbles 18′ provided by modified diffuser subsystem 45 This preferably enhances removal of PFAS from solution 12 having PFAS therein and, increases the production and distribution of foam or foamate 20.

Similar as discussed above with reference to FIG. 1, foam fractionation subsystem 14′ outputs flow 24 of foam or foamate 20 having the removed PFAS therein into flow 28 of heated dehumidified gas as shown such that flow 28 of a heated dehumidified gas collapses flow 24 of foam having the removed PFAS therein into flow 34 of liquid having the removed PFAS therein.

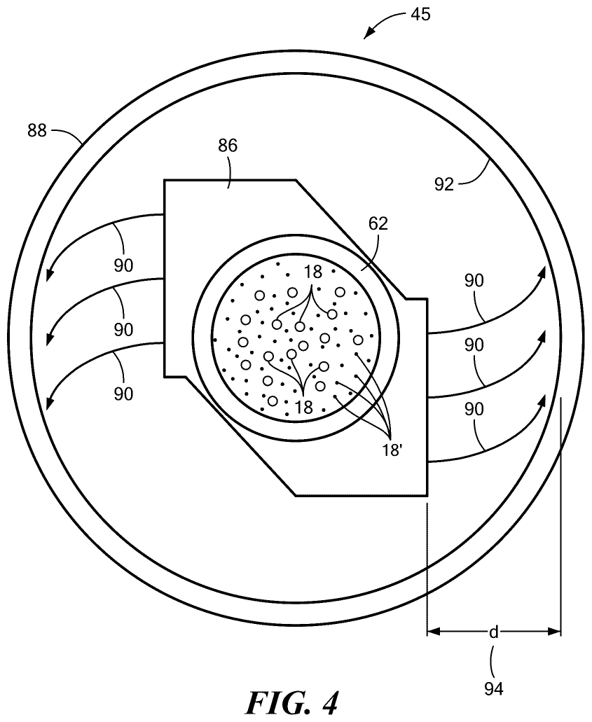

FIG. 4 is top view of modified diffuser subsystem 45 including vortex tee 86 and cylindrical baffle 88 and, shows an example of the direction of two-phase flow 90, also shown in FIG. 3, toward surface 92, FIG. 4, of cylindrical baffle 88, indicated by arrows 90. Preferably, vortex tee 86 is spaced from surface 92 by a predetermined distance, e.g., distance d-94, to maximize the rotational movement or vortex formation, which generates intense mixing and turbulence to augment the formation and distribution of microbubbles 18 and/or nanobubbles 18′ and, foam or foamate 20 to enhance removal of PFAS from solution 12 having PFAS therein. Distance d-94 will vary depending on the size of vessel 36′. The diameter of cylindrical baffle 88 is preferably chosen to maximize the rotational movement or vortex formation. A diameter too large or too small will provide non-optimal rotational movement or vortex formation. The diameter of cylindrical baffle 88 will vary depending on the size of vessel 36′.

In one exemplary operation, solution 12, FIG. 3, having PFAS therein enters vessel 36′ at inlet 70 as shown, e.g., as flow 16 of solution 12 having PFAS therein. As flow 16 travels down vessel 36′, indicated by arrows 100, the PFAS in flow 16 attaches to the high concentration of microbubbles 18 and/or nanobubbles 18′ provided by modified diffuser subsystem 45 and forms foam or foamate 20. As flow 16 travels further downward in vessel 36′, against the upward two-phase flow of microbubbles 18 and/or nanobubbles 18′ and solution 12 having PFAS therein, indicated by arrows 102, more PFAS attach to the highly concentrated microbubbles 18 and/or nanobubbles 18′. By the time flow 16 reaches the bottom of vessel 36′, indicated at 104, the majority of the PFAS has been removed and treated solution 21 is preferably output, e.g., as flow 22, in one example via outlet 110, and recycled flow 76 of solution 12 having PFAS therein is preferably directed to venturi eductor 72.

Foam fractionation subsystem 14′ preferably maintains solution 12 having PFAS therein in vessel 36′ at a desired surface level, e.g., surface level 130, e.g., by setting outlet 110 to height h-132 and/or adjusting control valve 134.

Cylindrical baffle 88, FIG. 4, is preferably sized and positioned, e.g., as shown, to separate the upward two-phase flow 102 of concentrated microbubbles 18 and/or nanobubble 18′ and solution 12 having PFAS therein from treated flow 22 of solution 12 and recycled flow 76 of solution 12 having PFAS therein.

Similar as discussed above with reference to FIGS. 1 and 2, flow 34, FIG. 3, of liquid having the removed PFAS therein and flow 28 of heated dehumidified gas may be directed to foamate break tank 40 which preferably collects flow 34 of liquid having the removed PFAS therein. Foamate break tank 40 preferably outputs flow 42 of liquid having the removed PFAS therein. Flow 42 may be a waste product that may be disposed of, destroyed, or further treated, as discussed below.

Similar as discussed above with reference to FIG. 1, in one design, line 52 coupled between heating and dehumidification subsystem 26 and foamate break tank 40 may be pitched to direct flow 34 of liquid having the majority of the removed PFAS therein to foamate break tank 40, similar as discussed above with reference to FIG. 2.

In one example, flow 28 of the heated dehumidified gas may be recirculated from foamate break tank 40 to heating and dehumidification subsystem 26 by line 50 and to vessel 36′ by line 52, similar as discussed above with reference to FIG. 1. Recirculating flow 28 of heated and dehumidified gas preferably reduces the energy input required to collapse flow 24 of foam into flow 34 of liquid having the removed PFAS therein.

Similar as discussed above with reference to FIG. 1, foam fractionation subsystem 14′ may also include collection tank 150 which receives condensate from dehumidifier 32 by line 152. The condensate in collection tank 150 may include PFAS and may be directed to inlet 70 by line 154 and/or super-loading subsystem 62 as flow 156 (discussed below).

Foam fractionation subsystem 14′, FIG. 3, may include super-loading subsystem 62, which preferably receives flow 42 of liquid having the majority of the removed PFAS therein and/or flow 156 as shown. Super-loading subsystem 62 preferably removes PFAS from flow 42 and/or flow 156 by sorbing PFAS onto adsorptive media to create concentrated PFAS waste product, similar as discussed above with reference to FIG. 1.

In one example, super-loading subsystem 62 may be configured as a small vessel, e.g., vessel 64 shown in caption 66 having an adsorptive media 68 therein. Adsorptive media 68 preferably adsorbs the PFAS in flow 42 to create concentrated PFAS waste product that may be disposed of or destroyed. Adsorptive media 68 may include anion exchange resin, granular activated carbon (GAC), synthetic media, or a combination thereof, or similar type adsorptive media. See e.g., U.S. Pat. Nos. 10,287,185, 10,913,668 and 11,027,988, cited supra.

Flow 28 of the heated dehumidified gas may be recirculated from foamate break tank 40 to heating and dehumidification subsystem 26 by line 50 and to vessel 36′ by line 52. Recirculating flow 28 of heated and dehumidified gas preferably reduces the energy input required to collapse flow 24 of foam into flow 34 of liquid having the PFAS therein.

Foam fractionation subsystem 14 may include exhaust vent 58 which preferably outputs flow 60 of exhausts gas. Flow 60 of exhaust gas is approximately equal to flow 56 of gas. Flow 60 may include trace amounts of PFAS. To remove any PFAS in flow 60, foam fractionation subsystem 14 may include exhaust gas removal subsystem 140 which preferably removes a majority of the PFAS from flow 60 and outputs flow 162 of treated exhaust gas. In one example, exhaust gas cleaning subsystem 148 may include a carbon canister, or similar type device.

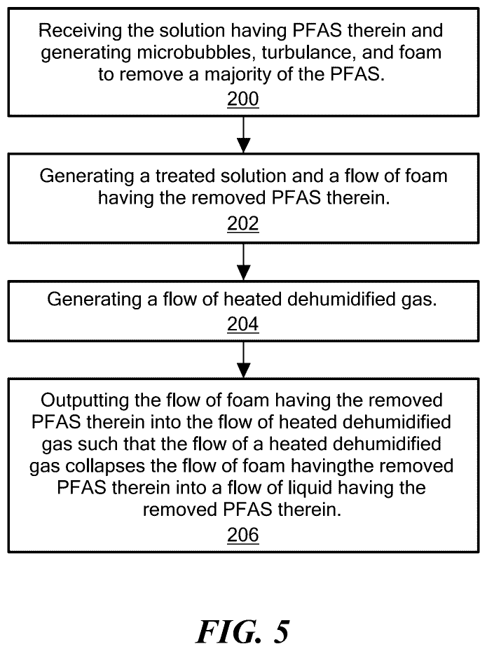

One example of the method for removing PFAS from a solution having PFAS therein using foam fractionation includes receiving the solution having PFAS therein and generating microbubbles, turbulence, and foam to remove a majority of the PFAS, step 200, FIG. 5, generating a treated solution and a flow of foam having the removed PFAS therein, step 202, generating a flow of heated dehumidified gas, step 204, and outputting the flow of foam having the removed PFAS therein into the flow of heated dehumidified gas such that the flow of a heated dehumidified gas collapses the flow of foam having the removed PFAS therein into a flow of liquid having the removed PFAS therein, step 206.

The result is system 10 and the method thereof efficiently and effectively removes PFAS from a solution having PFAS therein using foam fractionation. System 10 preferably reduces the volume of waste foam or foamate having removed PFAS therein and preferably creates a concentrated flow of a liquid having removed PFAS therein, or concentrated PFAS waste product, which preferably reduces the volume of PFAS waste.

Long-chain PFAS compounds, disclosed herein as “long-chain PFAS”, typically are designated having six or more carbons for perfluoroalkyl sulfonic acids and having seven or more carbons for perfluoroalkyl carboxylic acids. Short-chain PFAS compounds, disclosed herein as “short-chain PFAS”, typically have less than six carbons for perfluoroalkyl sulfonic acids and less than seven carbons for perfluoroalkyl carboxylic acids.

It is well known that is difficult to remove short-chain PFAS from a solution having PFAS therein using foam fractionation. Thus, conventional foam fractionation methods may be ineffective at removing both long and short-chain PFAS from a solution having PFAS therein.

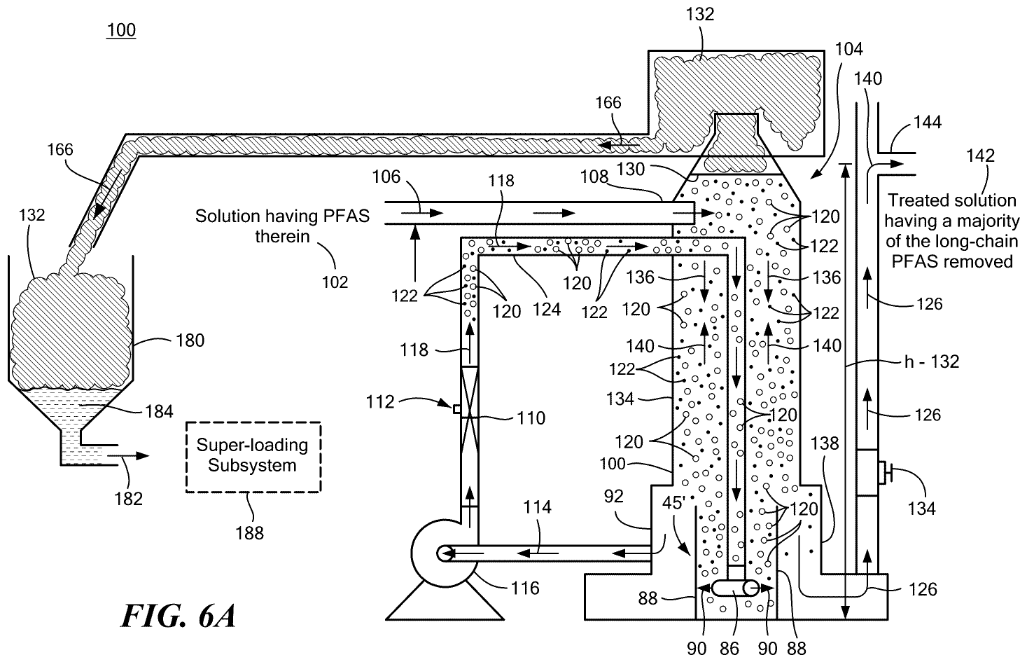

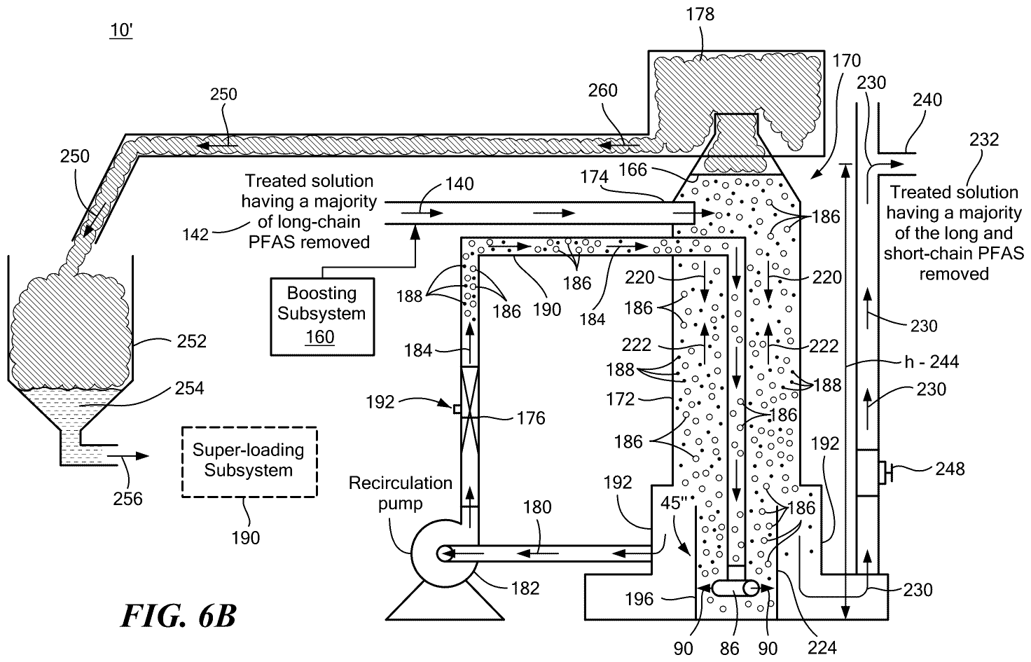

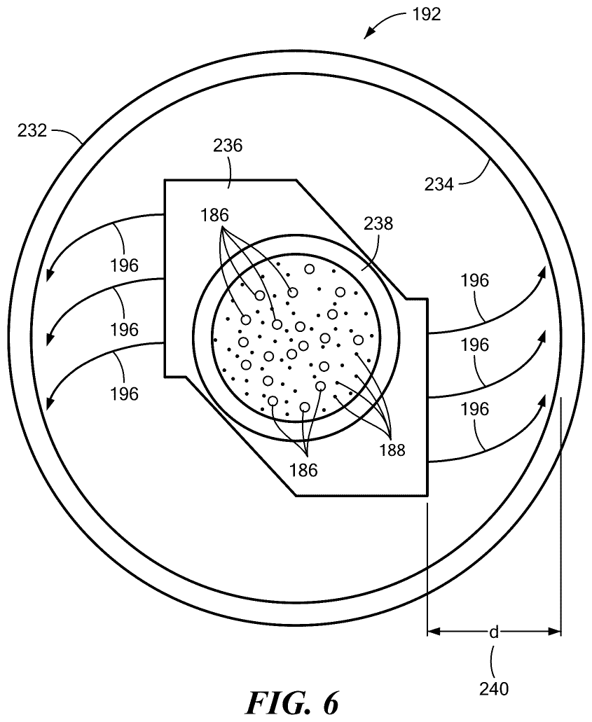

FIGS. 6A and 6B show one example of system 100 for removing long-chain and short-chain PFAS from solution 102 having PFAS therein using foam fractionation. Solution 102 may include one or more of industrial wastewater, municipal wastewater, contaminated groundwater, landfill leachate, dilute AFFF from fire protection systems, or similar solution contaminated with PFAS.

System 100 includes at least one first foam fractionation subsystem 104, FIG. 6A, which receives solution 102 having PFAS therein. In one design, first foam fractionation subsystem 104 may receive a flow of solution 102 having PFAS therein, e.g., flow 106 of solution 102 having PFAS therein. As disclosed herein, “flow” may be a continuous flow often utilized in a flow-through reactor or vessel, or an intermittent flow typically utilized in sequencing batch processing.

At least one first foam fractionation subsystem 104 generates microbubbles 120 and/or nanobubbles 122, turbulence, and foam 132 to remove a majority of long-chain PFAS and generate treated flow 140 of solution 142 having a majority of the long-chain PFAS removed, as discussed in detail below. As disclosed in this example, a majority is preferably greater than about 50% of the long-chain PFAS in solution 12.

First foam fractionation subsystem 104 preferably includes inlet 108 which receives flow 106 of solution 102 having PFAS therein. In this example, first foam fractionation subsystem 104 preferably includes venturi eductor 110 which introduces and mixes gas 112, e.g., air, nitrogen, carbon dioxide, or similar type gas, into recycled flow 114 of solution having PFAS therein provided by recirculation pump 116. Venturi eductor 110 preferably generates two-phase turbulent flow 118 of microbubbles 120 and/or nanobubbles 122 and solution 102 having PFAS therein in line 124.

First foam fractionation subsystem 104 preferably includes modified diffuser subsystem 45′, having a similar design and operation as modified diffuser 45 discussed above with reference to FIG. 3, which preferably induces intense mixing and turbulence to augment the formation and distribution of microbubbles 120 and/or nanobubbles 122 and foam or foamate 132 to enhance removal of long-chain PFAS from solution 102 having PFAS therein.

In one design, venturi eductor 110 preferably generates nanobubbles 122 by operating pump 116 in cavitation. Nanobubbles 122 preferably increase the surface area of air-water interface thereby enhancing efficiently of foam fractionation. In other examples, system 100 may include a nanobubble generation subsystem (not shown) to generate nanobubbles 122, as known by those skilled in the art.

System 100 also includes at least one second foam fractionation subsystem 170, FIG. 6B, which receives treated solution 142 having a majority of the long-chain PFAS removed and a foam boosting agent from foam booting subsystem 160, as discussed below. At least one second foam fractionation subsystem 170 preferably generates microbubbles 186 and/or nanobubbles 188, turbulence, and foam 178. The foam boosting agent preferably augments the formation of foam 178 to facilitate the removal of short-chain PFAS. At least one second foam fractionation subsystem 170 generates treated flow 230 of solution 232 having a majority of the long-chain PFAS removed and a majority of the short-chain PFAS removed. As defined herein, a majority is preferably greater than about 50% of the long-chain PFAS and 50% of the short-chain PFAS in solution 232.

In one exemplary operation, flow 106 of solution 102 having PFAS enters vessel 134. As flow 106 travels down vessel 134, indicated by arrows 136, the long-chain PFAS in flow 106 attach to the high concentration of microbubbles 120 and/or nanobubbles 122 provided by modified diffuser subsystem 45′ and forms foam or foamate 132. As flow 106 travels further downward in vessel 134, against the upward two-phase flow of microbubbles and solution 102 having PFAS therein, indicated by arrows 140, more long-chain PFAS attaches to the highly concentrated microbubbles 120 and/or nanobubbles 122. By the time flow 106 reaches the bottom of vessel 134, indicated at 138, the majority of the long-chain PFAS has been removed. At least one foam fractionation subsystem 104 produces flow 140, or raffinate 140, of treated solution 142 having majority of the long-chain PFAS removed. Flow 140 of treated solution 142 is preferably output by outlet 144, and recycled flow 114 of solution 102 having PFAS therein is preferably directed to venturi eductor 112.

In one example, first foam fractionation subsystem 104 preferably outputs flow 166 of foam 132 or foamate 132 which may be directed to foamate break tank 180 which preferably outputs flow 182, or liquid 182, of liquid 184 having a majority of the removed long-chain PFAS therein. In one example, flow 182 may be directed to super-loading subsystem 188, of similar design as super-loading subsystem 62, discussed above with reference to FIGS. 1 and 3, to create a concentrated PFAS waste product. The concentrated PFAS waste product may be disposed of or destroyed.

System 100 also includes foam boosting subsystem 160, FIG. 6B, which preferably injects at least one boosting agent into treated flow 140 of solution 142 having the majority of the long-chain PFAS removed. In one example, the foam boosting agent may include at least one supplemental surfactant. The supplemental surfactant may include an anionic, cationic, zwitterionic, nonionic, and/or a protein-based surfactant.

System 100 also preferably includes at least one second foam fractionation subsystem 170 which preferably includes vessel 172 and inlet 174 which receives treated flow 140 of solution 142 having a majority of the long-chain PFAS removed and the at least one foam boosting agent injected by foam boosting subsystem 160.

In this example, second foam fractionation subsystem 170 preferably includes venturi eductor 176 which introduces and mixes gas 192, e.g., air, nitrogen, carbon dioxide, or similar type gas, into recycled flow 180 of solution 142 having a majority of the long-chain PFAS removed, preferably provided by pump 182. Venturi eductor 176 preferably generates two-phase turbulent flow 184 of microbubbles 186 and/or nanobubbles 188 and treated solution 140 solution having a majority of the long-chain PFAS removed in line 190. In one example, venturi eductor 72 may be available from Mazzei Injector Company, LLC., Bakersfield, CA 93307.

In one design, venturi eductor 176 may generate nanobubbles 188 by operating pump 182 in cavitation. Nanobubbles 188 preferably increase the surface area of air-water interface thereby enhancing efficiently of foam fractionation. In other examples, system 100 may include a nanobubble generation subsystem (not shown) to generate nanobubbles 188, as known by those skilled in the art.

Second foam fractionation subsystem 170 also preferably includes modified diffuser subsystem 45″, of similar design and operation as modified diffuser subsystem 45 discussed above with reference to FIG. 3, which preferably induces intense mixing and turbulence to augment the production and distribution of microbubbles 186 and/or nanobubbles 188, and foam or foamate 178.

In one exemplary operation, flow 140 of treated solution 142 having the majority of long-chain PFAS removed and the booting agent introduced by foam boosting subsystem 160 into flow 140 enters vessel 172 at inlet 174. As flow 140 travels down vessel 172, indicated by arrows 220, the short-chain PFAS in flow 140 attach to the high concentration of microbubbles 186 and/or nanobubble 188 provided by modified diffuser subsystem 45″ and forms foam or foamate 178. As flow 140 travels further downward in vessel 172, against the upward two-phase flow of microbubbles 186 and/or nanobubbles 188 and solution 142 having the majority of the long-chain PFAS removed, indicated by arrows 222, short-chain PFAS attaches to the highly concentrated microbubbles 186 and/or nanobubble 188. The foam boosting agent discussed above augments the formation of foam 178 to facilitate the removal of a majority of the short-chain PFAS. The foam boosting agent preferably works by creating an ion pair with the short chain PFAS, thereby enhancing the foaming potential of the short chains, which do not t have as much natural foaming tendency as the longer chain PFAS. By the time flow 140 reaches the bottom of vessel 172, indicated at 224, the majority of the short-chain PFAS has been removed At least one second foam fractionation subsystem 170 preferably produces treated flow 230, or raffinate 230, of solution 232 having majority of the long-chain and short-chain PFAS removed. Treated flow or raffinate 230 is preferably output by outlet 240 and recycled flow 180 of solution 142 having a majority of the long-chain PFAS removed is preferably directed to venturi eductor 176.

In one design, second foam fractionation subsystem 172 preferably outputs flow 250 of foam or foamate 178 having majority of the removed short-chain PFAS therein. Flow 250 may include a small amount of liquid produced from foam or foamate 178 that has collapsed into a liquid. In one example, flow 250 is preferably directed to foamate break tank 252. In this example, foamate break tank 252 preferably collects flow 250 and collapses foam 176 into liquid 254 having a majority of the removed short-chain PFAS therein. Foamate break tank 252 preferably outputs treated flow 256 of liquid 254 having a majority of the short-chain PFAS removed therein. In one example, liquid flow 256 may be directed to super-loading subsystem 190, of similar design as super-loading subsystem 62, discussed above with reference to FIGS. 1 and 3, to create a concentrated PFAS waste product. The concentrated PFAS waste product may be disposed of or destroyed.

Although as discussed above with reference to FIGS. 6A and 6B, system 100 may utilize a modified diffuser subsystem for at least one first foam fractionation subsystem 104 and at least one second foam fractionation subsystem 170, in other designs, at least one first foam fractionation subsystem 104 and/or at least one second foam fractionation subsystem 170 may utilize a diffuser subsystem, such as diffuser subsystem 54, discussed above with reference to FIG. 1.

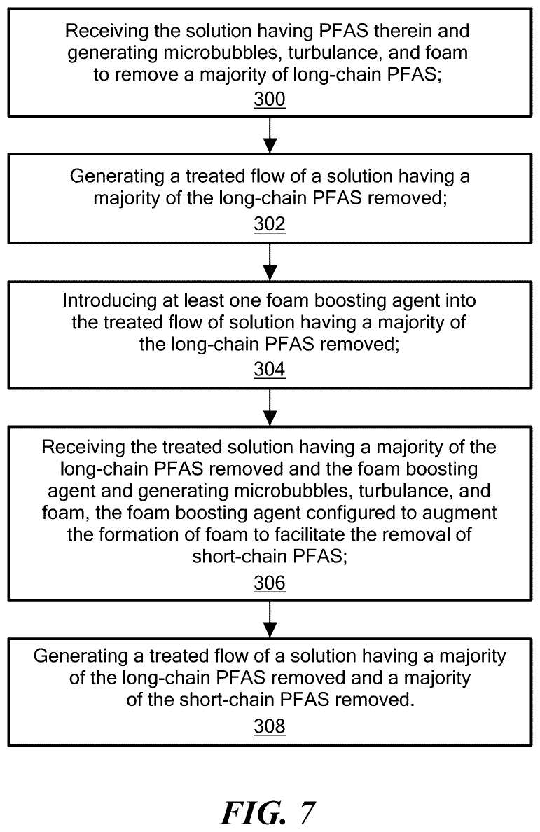

One example of the method for removing long-chain and short-chain PFAS from a solution having PFAS therein using foam fractionation includes receiving a solution having PFAS therein and generating microbubbles, turbulence, and foam to remove a majority of long-chain PFAS, step 300, FIG. 7, generating a treated flow of a solution having a majority of the long-chain PFAS removed, step 302, introducing at least one foam boosting agent into the treated flow of solution having a majority of the long-chain PFAS removed, step 304, receiving the treated solution having a majority of the long-chain PFAS removed and the foam boosting agent and generating microbubbles, turbulence, and foam, the foam boosting agent configured to augment the formation of foam to facilitate the removal of short-chain PFAS, step 306, and generating a treated flow of a solution having a majority of the long-chain PFAS and a majority of the short-chain PFAS therein., step 308.

Thus, the combination of first foam fractionation subsystem 104 in series with second foam fractionation subsystem 170 and foam boosting subsystem 160, which preferably introduces at least one foam boosting agent, effectively and efficiently removes a majority of the long-chain and short-chain PFAS from solution 102 having PFAS therein.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

Other embodiments will occur to those skilled in the art and are within the following claims.

What is claimed is:

1. A system for removing per-and polyfluoroalkyl substances (PFAS) from a solution having PFAS therein using foam fractionation, the system comprising:
at least one first foam fractionation subsystem including a vessel configured to receive the solution having PFAS therein and configured to generate microbubbles, turbulence, and foam to remove a majority of the PFAS and generate a treated solution and a flow of foam having the removed PFAS therein;
a heating and dehumidification subsystem coupled to the at least one foam fractionation subsystem and configured to generate a flow of heated dehumidified gas; and
the at least one foam fractionation subsystem configured to output the flow of foam having the removed PFAS therein into the flow of heated dehumidified gas such that the flow of a heated dehumidified gas collapses the flow of foam having the removed PFAS therein into a flow of liquid having the removed PFAS therein.

2. The system of claim 1 in which the flow of heated dehumidified gas is configured to reduce a volume of the flow of foam having the removed PFAS therein.

3. The system of claim 1 in which the flow of liquid having the removed PFAS therein and the heated dehumidified gas is directed to a foamate break tank.

4. The system of claim 3 including a pitched line coupled between the vessel and the foamate break tank configured to direct the flow of liquid having the removed PFAS therein to the foamate break tank.

5. The system of claim 4 in which the flow of heated dehumidified gas is recirculated from the foamate break tank to the heating and dehumidification subsystem and to the vessel.

6. The system of claim 5 in which recirculating the heated and dehumidified gas is configured to reduce an energy input required to collapse and/or reduce the volume of the foam.

7. The system of claim 1 in which the at least one foam fractionation subsystem includes a diffuser subsystem configured to generate the microbubbles and/or nanobubbles, the turbulence, and the foam.

8. The system of claim 1 in which the at least one foam fractionation subsystem includes:
a venturi eductor configured to introduce and mix a gas into a recycled solution having PFAS therein and generate a two-phase flow of microbubbles and a solution having PFAS therein, and
modified diffuser including a vortex tee inside a cylindrical baffle configured to receive the two-phase flow and induce rotational movement that generates intense mixing and turbulence to augment the formation and distribution of microbubbles and foam to enhance removal of PFAS from the solution having PFAS therein.

9. The system of claim 8 in which the vortex tee is spaced from a surface of the cylindrical baffle by a predetermined distance to maximize the rotational movement and turbulence of the two-phase flow of microbubbles and water having PFAS therein.

10. The system of claim 8 in which the cylindrical baffle is sized and positioned to separate the two-phase flow of microbubbles and water having PFAS therein from the treated solution having a majority of the PFAS removed.

11. The system of claim 8 including at least one pump coupled to the vessel and the venturi eductor, the at least one pump operated in cavitation such that the venturi eductor generates a two-phase flow of microbubbles and/or nanobubbles and the solution having PFAS therein.

12. The system of claim 11 in which the modified diffuser is configured to receive the two-phase flow and induce rotational movement that generates intense mixing and turbulence to augment the formation and distribution of microbubbles and/or nanobubbles and foam to enhance removal of PFAS from the solution having PFAS therein.

13. The system of claim 1 including a super-loading subsystem configured to receive the flow of liquid having the removed PFAS therein and configured to remove PFAS from the flow by sorbing PFAS onto adsorptive media to create a concentrated PFAS waste product.

14. A method for removing per-and polyfluoroalkyl substances (PFAS) from a solution having PFAS therein using foam fractionation, the method comprising:
receiving the solution having PFAS therein and generating microbubbles, turbulence, and foam to remove a majority of the PFAS;
generating a treated solution and a flow of foam having the removed PFAS therein.
generating a flow of heated dehumidified gas; and
outputting the flow of foam having the removed PFAS therein into the flow of heated dehumidified gas such that the flow of a heated dehumidified gas collapses the flow of foam having the removed PFAS therein into a flow of liquid having the removed PFAS therein.

15. The method of claim 14 in which the flow of heated dehumidified gas is configured to reduce a volume of the flow of foam having the removed PFAS therein.

16 The method of claim 14 in which the flow of liquid having the removed PFAS therein and the heated dehumidified gas is directed to a foamate break tank.

17. The method of claim 16 in which the flow of heated dehumidified gas is recirculated from the foamate break tank to the heating and dehumidification subsystem and to the vessel.

18. The method of claim 17 in which recirculating the heated and dehumidified gas is configured to reduce an energy input required to collapse and/or reduce the volume of the foam.

19. The method of claim 14 including a super-loading process configured to receive the flow of liquid having the removed PFAS therein and configured to remove PFAS from the flow by sorbing PFAS onto adsorptive media to create a concentrated PFAS waste product.

20. A system for removing long-chain and short-chain per-and polyfluoroalkyl substances (PFAS) from a solution having PFAS therein using foam fractionation, the system comprising
at least one first foam fractionation subsystem configured to receive the solution having PFAS therein and configured to generate microbubbles, turbulence, and foam to remove a majority of long-chain PFAS and generate a treated flow of a solution having a majority of the removed long-chain PFAS therein;
at least one foam boosting subsystem configured to introduce at least one foam boosting agent into the treated flow of solution having a majority of the removed long-chain PFAS therein; and
at least one second foam fractionation subsystem configured to receive the treated solution having a majority of the removed long-chain PFAS therein and the foam boosting agent, the at least one second foam fractionation subsystem configured to generate microbubbles, turbulence, and foam, the foam boosting agent configured to augment the formation of foam to facilitate the removal of short-chain PFAS, the at least one second foam fractionation subsystem configured to generate a treated flow of a solution having a majority of the long-chain PFAS removed and a majority of the short-18 chain PFAS removed.

21. The system of claim 20 in which the foam boosting agent includes at least one supplemental surfactant.

22. The system of claim 21 in which the at least one supplemental surfactant includes an anionic, cationic, zwitterionic, nonionic, and/or a protein-based surfactant.

23. A method for removing long-chain and short-chain per- and polyfluoroalkyl substances (PFAS) from a solution having PFAS therein using foam fractionation, the method comprising
receiving the solution having PFAS therein and generating microbubbles, turbulence, and foam to remove a majority of long-chain PFAS;
generating a treated flow of a solution having a majority of the long-chain PFAS removed;
introducing at least one foam boosting agent into the treated flow of solution having a majority of the long-chain PFAS removed;
receiving the treated solution having a majority of the long-chain PFAS removed and the foam boosting agent and generating microbubbles, turbulence, and foam, the foam boosting agent configured to augment the formation of foam to facilitate the removal of short-chain PFAS; and
generating a treated flow of a solution having a majority of the long-chain PFAS removed and a majority of the short-chain PFAS removed.

24. The method of claim 23 in which the foam boosting agent includes at least one supplemental surfactant.

25. The method of claim 24 in which the at least one supplemental surfactant. includes an anionic, cationic, zwitterionic, nonionic, and/or a protein-based surfactant.
